(19) United States
(12) Patent Application Publication
(10) Pub. No.: US 2013/0270725 A1
(43) Pub. Date: Oct. 17, 2013

(54) METHOD OF MAKING LENS

(71) Applicants: Ching-Shan Yang, Tainan (TW); Wu-Li Wang, Tainan (TW)

(72) Inventors: Ching-Shan Yang, Tainan (TW); Wu-Li Wang, Tainan (TW)

(73) Assignee: GLOBAL MICROPTICS COMPANY, Tainan (TW)

(21) Appl. No.: 13/446,766

(22) Filed: Apr. 13, 2012

(51) Int. Cl. B29D 11/00

(52) U.S. Cl. 264/1.24; 264/1.36; 264/1.38

(57) ABSTRACT

A method of making lenses includes the following steps: A. Provide a photo-curing material into a cavity between a first die and a second die. B. Expose the photo-curing material under predetermined light, whereby the photo-curing material is solidified, and a transmittance of the solidified photo-curing material is greater than 75%. C. Remove the first die and the second die to obtain a lens material; and D. Cut the lens material to obtain a plurality of lenses.

### BACKGROUND OF THE INVENTION

1. Field of the Invention

The present invention relates generally to an optical device, and more particularly to a method of making lenses.

2. Description of the Related Art

In recent days, consumer electronic devices, such as cell phone, laptop, tablet, and PDA, are equipped with lens module to catch images. These consumer electronic devices are made as smaller and lighter as possible for user to carry and operate in an easy way so that lens modules and the lens mounted in the lens module are asked smaller and lighter accordingly.

A conventional method of making such lens includes the following steps:

A. Provide molten thermosetting epoxy on a glass substrate, and flip a first die on the epoxy and press it.

B. Heat the epoxy for curing to form a first lens portion on a side of the glass substrate.

C. Remove the first die.

D. Provide molten thermosetting epoxy on the other side of the glass substrate, and flip a second die on the epoxy and press it.

E. Heat the epoxy for curing to form a second lens portion on the other side of the glass substrate.

F. Remove the second die to obtain a lens with the first lens portion and the second lens portion on opposite side of the glass substrate.

It will take a long time to mold a lens by the conventional method as described above because it only molds a side of the lens once. Besides, the lens made by the conventional method has a glass substrate therein. It is obviously that the glass substrate limits the thickness of the lens. Therefore, it still has some places to be improved.

### SUMMARY OF THE INVENTION

The primary objective of the present invention is to provide a method of making a lens, which makes thin lenses in a fast way.

According to the objective of the present invention, a method of making lenses includes the following steps:

A. Provide a photo-curing material into a cavity between a first die and a second die.

B. Expose the photo-curing material under predetermined light, whereby the photo-curing material is solidified, and a transmittance of the solidified photo-curing material is greater than 75%.

C. Remove the first die and the second die to obtain a lens material.

D. Cut the lens material to obtain a plurality of lenses.

In an embodiment, the step A further includes the steps of putting a bulk of the photo-curing material on the second die, and pressing the first die onto the second die to fill the cavity with the photo-curing material.

In an embodiment, the step A further includes the step of providing the molten photo-curing material into the cavity.

In an embodiment, the photo-curing material is UV-curing material, and the UV-curing material is exposed under UV light in the step B.

In an embodiment, the photo-curing material is photo-curing epoxy.

In an embodiment, an adhesion force between the first die and the solidified photo-curing material is greater than an adhesion force between the second die and the solidified photo-curing material so that the second die is separated from the solidified photo-curing material prior to the first die in the step C.

In an embodiment, the method of the present invention further includes the steps of attaching a separating device to the solidified photo-curing material after the second die is separated from the solidified photo-curing material, wherein an adhesion force between the separating device and the solidified photo-curing material is greater than the adhesion force between the first die and the solidified photo-curing material; removing the first die from the solidified photo-curing material and the separating device, and then removing the separating device from the solidified photo-curing material.

In an embodiment, the separating device is separated from the solidified photo-curing material prior to the step D.

In an embodiment, the separating device is separated from the solidified photo-curing material after the step D.

In an embodiment, the method of the present invention further includes the step of providing a chemical solution to the separating device to decompose it in order to remove the separating device from the solidified photo-curing material.

In an embodiment, the method of the present invention further includes the step of coating at least an optical film on the solidified photo-curing material prior to the step D.

In an embodiment, both the first die and the second die are transparent.

In an embodiment, one of the first die and the second die has a flat side, and the other has a cavity.

In an embodiment, both the first die and the second die respectively have a cavity.

In an embodiment, the transmittance of the solidified photo-curing material is greater than 95%.

Therefore, the present invention is faster than the conventional method, and the lenses made by the method of the present invention are thinner and lighter than the lenses made by the conventional method.

### BRIEF DESCRIPTION OF THE DRAWINGS

FIG. 1 is a flow chart of a preferred embodiment of the present invention;

FIG. 2 and FIG. 3 are sketch diagrams of the step A of the preferred embodiment of the present invention;

FIG. 4 to FIG. 7 are sketch diagrams of the step C of the preferred embodiment of the present invention; and

FIG. 8 is sketch diagram of the step D of the preferred embodiment of the present invention.

### DETAILED DESCRIPTION OF THE INVENTION

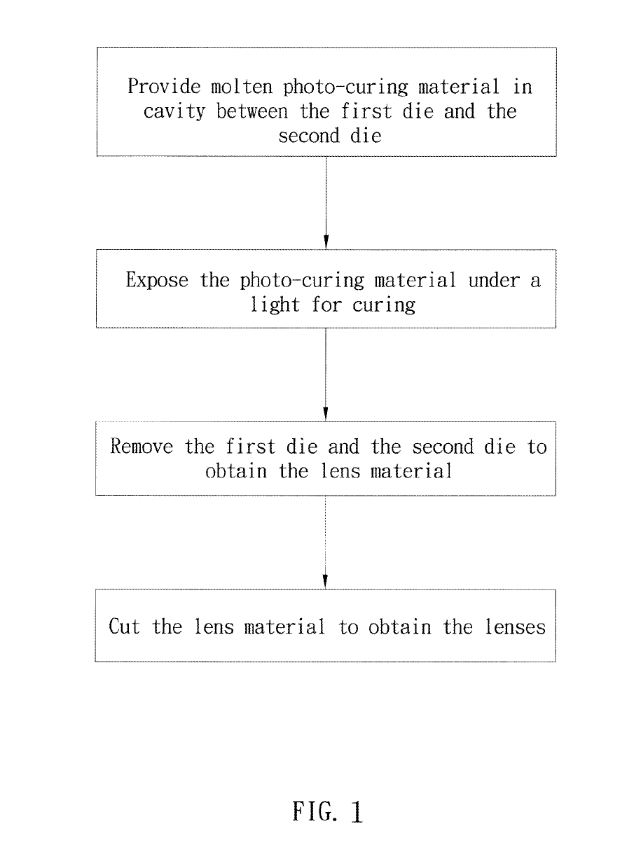

As shown in FIG. 1, a method of making lenses of the preferred embodiment of the present invention includes the following steps:

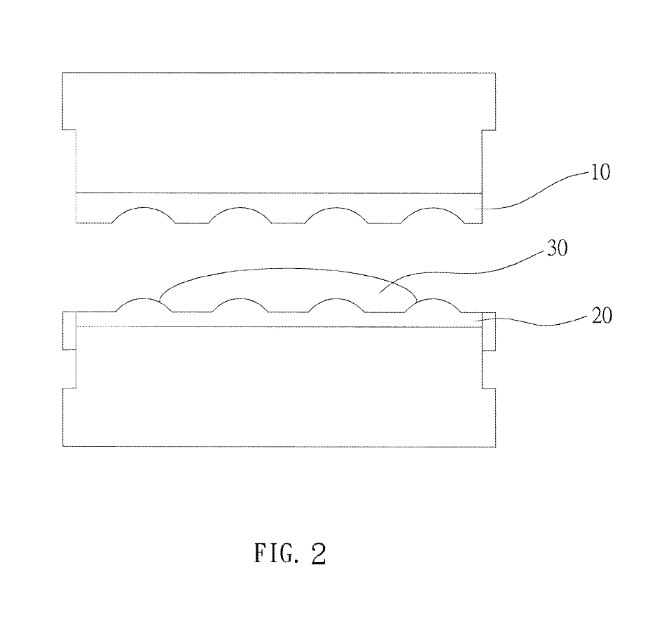

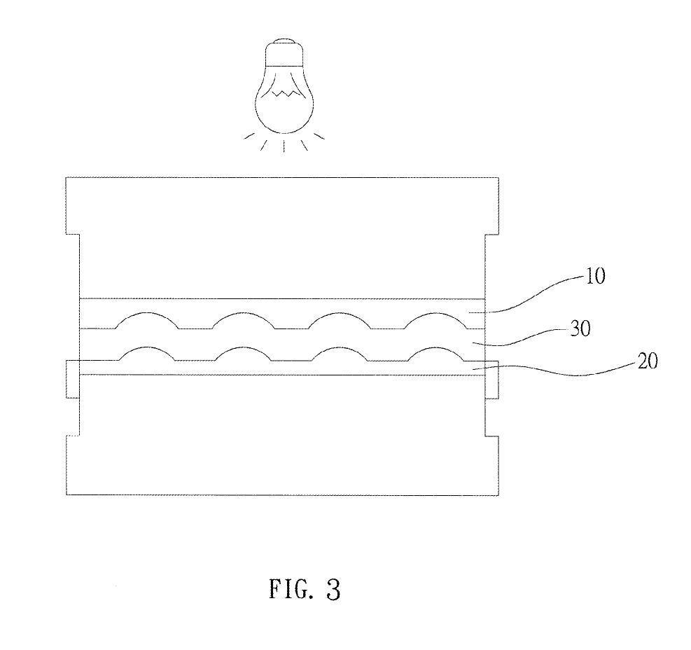

A. As shown in FIG. 2 and FIG. 3, provide a molten photo-curing material 30 in a cavity between a first die 10 and a second die 20. The first die 10 and the second die 20 respectively have a recess to form the cavity. In the present embodiment, a bulk of UV-curing epoxy 30 is put on the second die 20, and then the first die 10 is put on second die 20 and pressed to press the epoxy 30 to let it fill the entire cavity between the first die 10 and the second die 20. An alternate way is pouring or injecting the molten UV-curing epoxy into the cavity.

B. Expose the molten photo-curing material 30 under predetermined light. In the present embodiment, the first die 10 and the second die 20 are transparent, and an UV lamp is moved above the dies 10, 20 to illuminate the UV-curing epoxy 30 through the die in order to solidify the material 30. In an embodiment, a transmittance of the solidified material 30 is greater than 75%, and more preferable is greater than 95%. Many facts, such as the photo-curing material used for molding, the amount of the photo-curing material put in the cavity, and the shape and size of the cavity, limit the light for curing, the time of exposure, and intensity of the light, one having ordinary skill in material molding may easily find the best combination. After curing, the solidified material 30 has a first adhesion force with the first die 10 and a second adhesion force with the second die 20, and the first adhesion force is greater than the adhesion force.

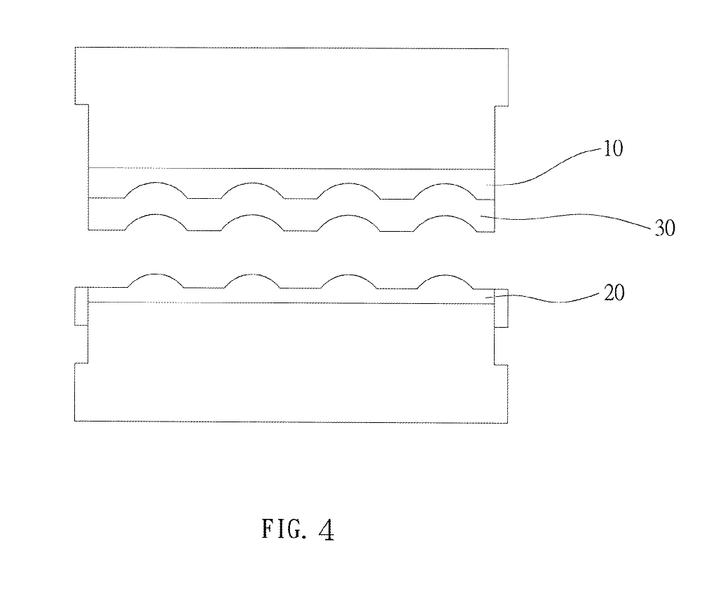

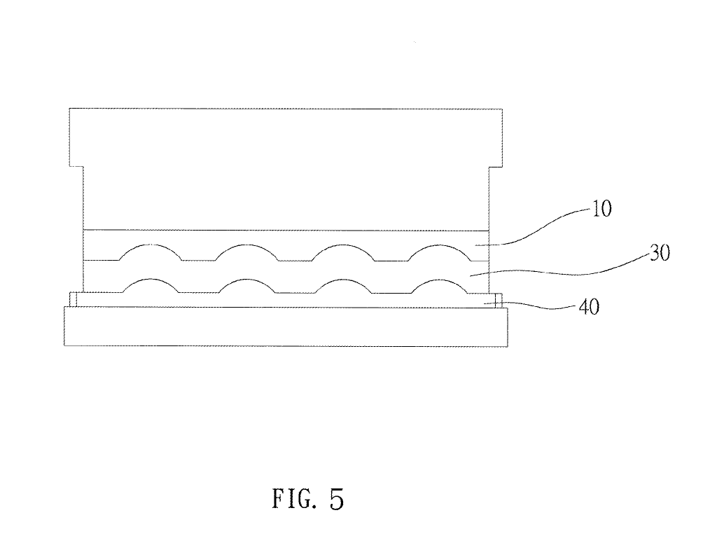

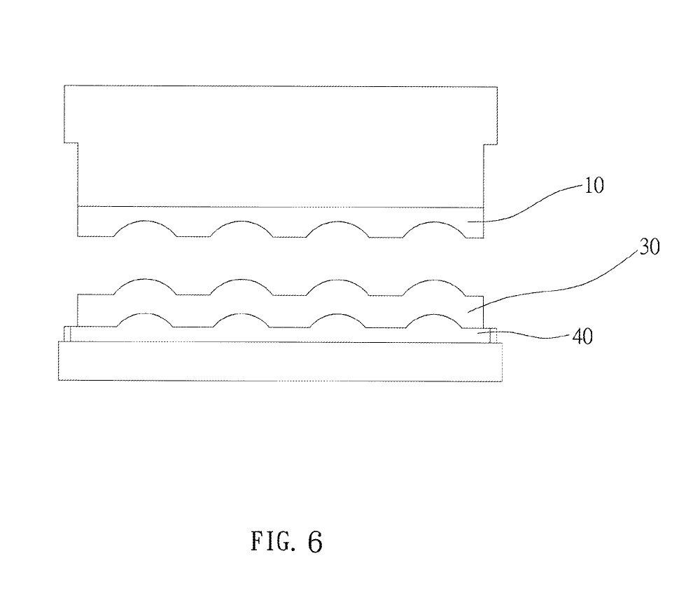

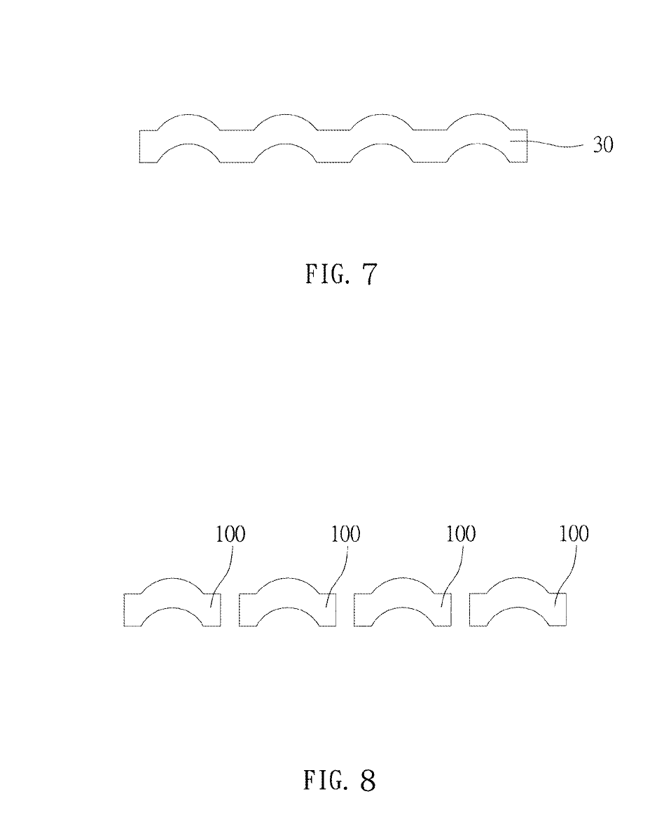

C. Remove the first die 10 and the second die 20 to obtain a lens material 30. In the present embodiment, as shown in FIG. 4, because of the difference of the adhesion forces, the second die 20 is separated from the lens material 30 first and the lens material 30 still is attached to the first die 10 when pulling the dies 10, 20 to separate them. And then, as shown in FIG. 5, attach a separating device 40 to the lens material 30. A third adhesion force between the separating device 40 and the lens material 30 is greater than first adhesion force between the first die 10 and the lens material 30, so that exerting the separating device 40 and the first die 10 may separate the lens material 30 from the first die 10 (FIG. 6). At this stage, it may coat a predetermined optical film, such as IR cut filter, on the lens material 30 to provide the lenses with predetermined optical functions. Next, a chemical solution is provided to the separating device 40 to decompose it, and then the lens material 30 is obtained (FIG. 7).

D. Cut the lens material 30 to obtain a plurality of lenses 100 (FIG. 8). It is easy to understand that it may cut the lens material 30 before the separating device 40 is removed.

The present invention uses the photo-curing material to make the lenses. It may shorten the time of manufacture, and furthermore, the lenses 100 made by the method of the present invention has no glass substrate, therefore, the lenses 100 will be thinner and lighter than the conventional lenses as described in the prior art.

In above embodiment both dies have a recess to form the cavity. In practice, one of the dies may be flat and the other one has the recess so that the lens will have a flat side. The description above is a few preferred embodiments of the present invention and the equivalence of the present invention is still in the scope of claim construction of the present invention.

What is claimed is:

1. A method of making lenses, comprising the steps of:
A. providing a photo-curing material into a cavity between a first die and a second die;
B. exposing the photo-curing material under predetermined light to solidify the photo-curing material, wherein a transmittance of the solidified photo-curing material is greater than 75%;
C. removing the first die and the second die to obtain a lens material; and
D. cutting the lens material to obtain a plurality of lenses.

2. The method as defined in claim 1, wherein the step A further comprising the steps of putting a bulk of the photo-curing material on the second die, and pressing the first die onto the second die to fill the cavity with the photo-curing material.

3. The method as defined in claim 1, wherein the step A further comprising the step of providing the molten photo-curing material into the cavity.

4. The method as defined in claim 1, wherein the photo-curing material is UV-curing material, and the UV-curing material is exposed under UV light in the step B.

5. The method as defined in claim 1, wherein the photo-curing material is photo-curing epoxy.

6. The method as defined in claim 1, wherein an adhesion force between the first die and the solidified photo-curing material is greater than an adhesion force between the second die and the solidified photo-curing material so that the second die is separated from the solidified photo-curing material prior to the first die in the step C.

7. The method as defined in claim 6, further comprising the steps of attaching a separating device to the solidified photo-curing material after the second die is separated from the solidified photo-curing material, wherein an adhesion force between the separating device and the solidified photo-curing material is greater than the adhesion force between the first die and the solidified photo-curing material; removing the first die from the solidified photo-curing material and the separating device, and then removing the separating device from the solidified photo-curing material.

8. The method as defined in claim 7, wherein the separating device is separated from the solidified photo-curing material prior to the step D.

9. The method as defined in claim 7, wherein the separating device is separated from the solidified photo-curing material after the step D.

10. The method as defined in claim 7, further comprising the step of providing a chemical solution to the separating device to decompose it in order to remove the separating device from the solidified photo-curing material.

11. The method as defined in claim 1, further comprising the step of coating an IR cut filter on the solidified photo-curing material prior to the step D.

12. The method as defined in claim 1, wherein both the first die and the second die are transparent.

13. The method as defined in claim 1, wherein one of the first die and the second die has a flat side, and the other has a recess to form the cavity.

14. The method as defined in claim 1, wherein both the first die and the second die respectively have a recess to form the cavity.

15. The method as defined in claim 1, wherein the transmittance of the solidified photo-curing material is greater than 95%.
